(19) United States
(12) Patent Application Publication
(10) Pub. No.: US 2015/0097748 A1
(43) Pub. Date: Apr. 9, 2015

(54) WIDE BAND LTE ANTENNA

(71) Applicant: PC-TEL, Inc., Bloomingdale, IL (US)

(72) Inventors: Jin Hao, Palatine, IL (US); Miroslav Parvanov, Naperville, IL (US)

(21) Appl. No.: 14/509,698

(22) Filed: Oct. 8, 2014

Related U.S. Application Data
(60) Provisional application No. 61/888,118, filed on Oct. 8, 2013.

(51) Int. Cl. H01Q 21/26; H01Q 5/00

(52) U.S. Cl. CPC H01Q 21/26; H01Q 5/0027
USPC 343/797

(57) ABSTRACT

A wide band LTE antenna that can operate in a frequency range of from approximately 690 MHz to approximately 2700 MHz is provided. The antenna can include a first PCB including a first conductor and a second PCB including a second conductor. A first plurality of arms of the first conductor and a first plurality of arms of the second conductor can be connected to a feed microstrip line disposed on a first side of the second PCB, a second plurality of arms of the first conductor and a second plurality of arms of the second conductor can be connected to a ground connection disposed on a second side of the second PCB, and the feed microstrip line can avoid connection with the second plurality of arms of the first conductor and with the second plurality of arms, of the second conductor.

### CROSS-REFERENCE TO RELATED APPLICATIONS

This application claims priority to U.S. Provisional Patent Application No. 61/888,118 filed Oct. 8, 2013 and titled “Wide Band LTE Antenna”. U.S. Application No. 61/888,118 is hereby incorporated by reference.

### FIELD

The present invention relates generally to antennas and telecommunications. More particularly, the present invention relates to a wide band LTE (Long-Term Evolution) antenna.

### BACKGROUND

Many known dipole antennas include three pieces of printed circuit board (PCB) and are fed by a cable. However, such a configuration makes these antennas difficult to tune to match other frequencies and/or a RL performance level. For example, there is nowhere to tune known dipole antennas except for the antennas themselves. Additionally, such known configurations add to the cost of the antennas because of the number of parts required as well as the need for labeling for soldering.

In view of the above, there is a need for an improved antenna.

### BRIEF DESCRIPTION OF THE DRAWINGS

FIG. 1 is a graph of an exemplary standing wave ratio for an antenna in accordance with disclosed embodiments;

FIG. 2A is a top view of a first printed circuit board of an antenna in accordance with disclosed embodiments;

FIG. 2B is a bottom view of a first printed circuit board of an antenna in accordance with disclosed embodiments;

FIG. 3A is a top view of a second printed circuit board of an antenna in accordance with disclosed embodiments;

FIG. 3B is a bottom view of a second printed circuit board of an antenna in accordance with disclosed embodiments;

FIG. 4A is a perspective view of first and second printed circuit boards of an antenna in accordance with disclosed embodiments prior to insertion into one another;

FIG. 4B is an enlarged view of a section of the antenna shown in FIG. 4A;

FIG. 5A is a perspective view of first and second printed circuit boards of an antenna in accordance with disclosed embodiments inserted into one another;

FIG. 5B is an enlarged view of a section of the antenna shown in FIG. 5A; and

FIG. 6 is a top view of first and second printed circuit boards of an antenna in accordance with disclosed embodiments inserted into one another.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a wide band LTE antenna that can operate in a frequency range of from approximately 690 MHz to approximately 2700 MHz with good performance. Embodiments disclosed herein also include an antenna that includes fewer parts as compared to known dipole antennas, thereby making the antenna disclosed herein cost effective from a parts, manufacturing, and labor perspective.

In some embodiments, the antenna disclosed herein can be formed of two pieces of PCB and can include a dipole etched and/or deposited on the PCBs. The dipole can include sixteen arms.

The two pieces of PCB can be inserted into each other to form a crossed dipole, and each piece of PCB can include a respective conductor of the dipole. Each conductor can include eight arms.

Because the two pieces of PCB occupy more space than a single piece of PCB, the two pieces of PCB can support the wide frequency band of the antenna. Additionally, because the dipole is a crossed dipole, the antenna and the dipole can be symmetrical, thereby producing antenna radiation patterns that are also symmetrical and/or round.

As explained above, each conductor of the dipole can include eight arms: first and second upper arms etched and/or deposited on a first side of a respective PCB, first and second upper arms etched and/or deposited on a second side of the respective PCB, first and second lower arms etched and/or deposited on the first side of the respective PCB, and first and second lower arms etched and/or deposited on the second side of the respective PCB. In some embodiments, some or all of the sixteen upper arms of the dipole can be physically and electrically connected with each other as well as to a feed microstrip line by solder and/or via holes disposed in the arms. Furthermore, in some embodiments, some or all of the sixteen lower arms of the dipole can be physically and electrically connected with each other as well as with ground by a ground connection, solder, and/or a bridge, for example, a solderable wire.

In some embodiments, the antenna disclosed herein can include a ground connection on a first side of one of the PCBs and a feed microstrip line on a second side of the one of the PCBs. The feed microstrip line can be used to easily tune the antenna to match the wide frequency band of the antenna without the need for a cable to feed the antenna. Indeed, in some embodiments, the feed microstrip line can cross the lower arms of the dipole to feed the upper arms of the dipole without disturbing the lower arms of the dipole.

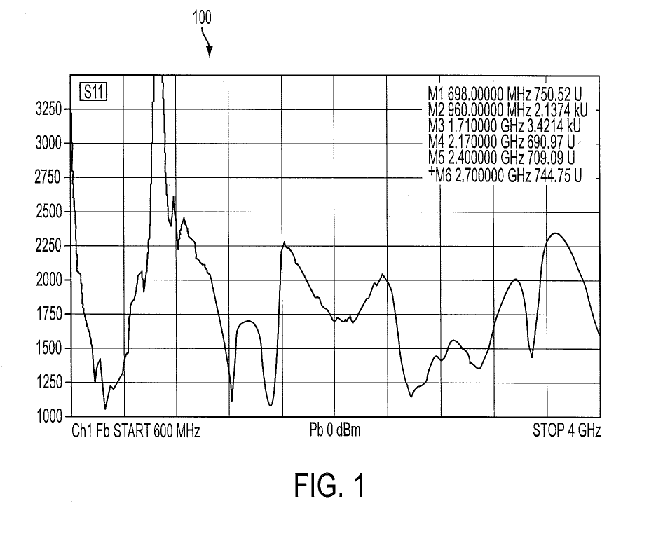

FIG. 1 is a graph 100 of an exemplary standing wave ratio for an antenna in accordance with disclosed embodiments. As seen, the antenna can operate in a frequency range of from approximately 690 MHz to approximately 2700 MHz with good performance.

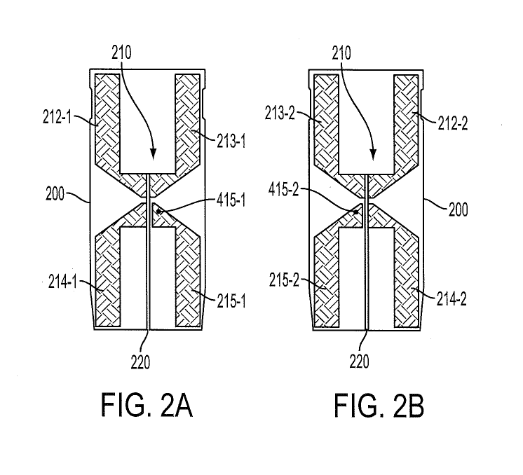

FIG. 2A is a top view of a first PCB 200 of an antenna in accordance with disclosed embodiments, and FIG. 2B is a bottom view of the first PCB 200 of the antenna in accordance with disclosed embodiments. As seen, the first PCB 200 can include a conductor 210 etched and/or deposited thereon. The conductor 210 can include first and second upper arms 212-1, 213-3 on the top side of the PCB 200 and first and second upper arms 212-2, 213-2 on the bottom side of the PCB 200. Similarly, the conductor 210 can include first and second lower arms 214-1, 215-1 on the top side of the PCB 200 and first and second lower arms 214-2, 215-2 on the bottom side of the PCB 200.

As seen in FIGS. 2A and 2B, in some embodiments, the first PCB 200 can also include a notch 220, cut-out, or other aperture therein that extends from a bottom end of the PCB 200 to a generally middle portion of the PCB 200 along a central vertical axis of the PCB 200. End portions of the first and second upper arms 212-1, 213-1, 212-2, 213-2 and end portions of the first lower arms 214-1, 214-2 can abut at least a portion of the notch 220. However, in some embodiments, entire portions of the second lower arms 215-1, 215-2 can be separated from the notch 220. Indeed, as seen in FIGS. 2A and 2B, end portions of the second lower arms 215-1, 215-2 can be separated from the notch 220 by a gap on the PCB 200. When the PCB 200 is engaged with a second PCB 300, such a gap on the PCB 200 can prevent the second lower arms 215-1, 215-2 from connecting with the feed microstrip line 335 explained and described herein.

As further seen in FIGS. 2A and 2B, in some embodiments, the second lower arms 215-1, 215-2 can include respective apertures 415-1, 415-2 disposed therethrough, and the PCB 200 can include an aperture at a corresponding point. As further explained herein, a bridge 400 can pass through apertures 415-1, 415-2 for connecting the second lower arms 215-1, 215-2 to ground.

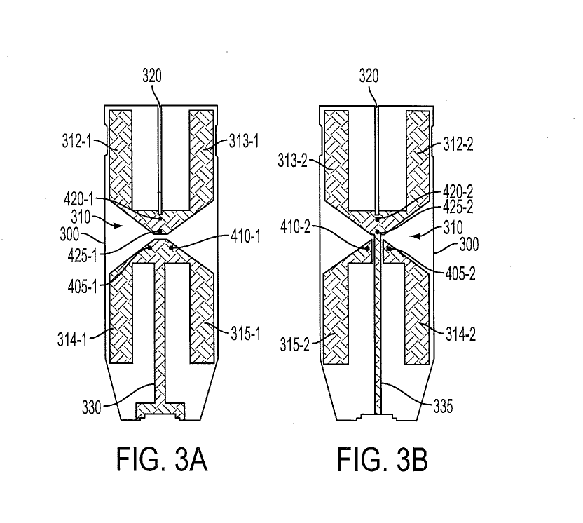

FIG. 3A is a top view of a second PCB 300 of an antenna in accordance with disclosed embodiments, and FIG. 3B is a bottom view of the second PCB 300 of the antenna in accordance with disclosed embodiments. As seen, the second PCB 300 can include a conductor 310 etched and/or deposited thereon. The conductor 310 can include first and second upper arms 312-1, 313-1 on the top side of the PCB 300 and first and second upper arms 312-2, 313-2 on the bottom side of the PCB 300. Similarly, the conductor 310 can include first and second lower arms 314-1, 315-1 on the top side of the PCB 300 and first and second lower arms 314-2, 315-2 on the bottom side of the PCB 300.

As seen in FIGS. 3A and 3B, the second PCB 300 can also include a ground connection 330 on the top side of the PCB 300 and a feed microstrip line 335 on the bottom side of the PCB 300. In some embodiments, the ground connection 330 can be physically and electrically connected to the first and second lower arms 314-1, 315-1 on the top side of the PCB 300. Similarly, in some embodiments, the feed microstrip line 335 can be physically and electrically connected to the first and second upper arms 312-2, 313-2 on the bottom side of the PCB 300. However, as seen in FIG. 3B, the feed microstrip line 335 can cross the first and second lower arms 314-2, 315-2 on the bottom side of the PCB 300 to feed the first and second upper arms 312-2, 313-2 on the bottom side of the PCB 300 without physically or electrically connecting to the first and second lower arms 314-2, 315-2.

As further seen in FIGS. 3A and 3B, in some embodiments, the second PCB 300 can include a notch 320, cut-out, or other aperture therein that extends from a top end of the PCB 300 to a generally middle portion of the PCB 300 along a central vertical axis of the PCB 300.

In some embodiments, the first and second lower arms 314-1, 315-1, 314-2, 315-2 can include respective apertures 405-1, 410-1, 405-2, 410-2 disposed therethrough, and the PCB 300 can include apertures at corresponding points. As further explained herein, a bridge can connect with and/or be passed through apertures 405-1, 410-1, 405-2, 410-2 for connecting the lower arms 314-2, 315-2 to ground.

Furthermore, the first and second upper arms 312-1, 313-1, 312-2, 313-2 can include respective via holes 420-1, 425-1, 420-2, 425-2 disposed therethrough, and the PCB 300 can include apertures at corresponding points. As further explained herein, solder can pass through via holes 420-1, 425-2, 420-2, 425-2 to connect the upper arms 212-1, 213-1, 212-2, 213-2, 312-1, 313-1 with the feed microstrip line 335.

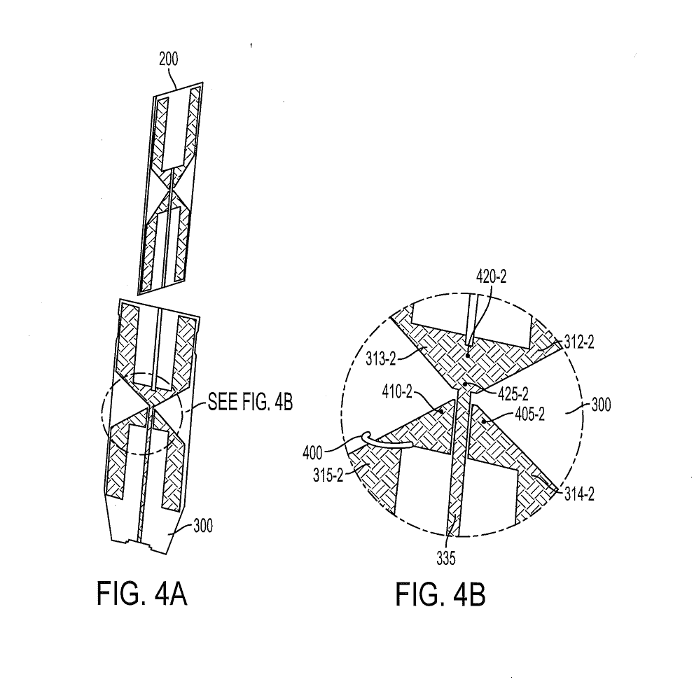

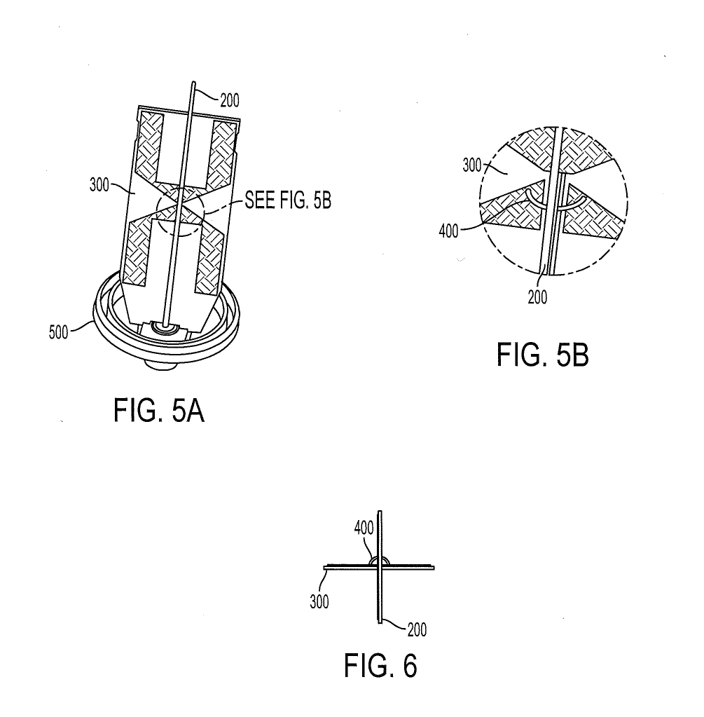

As explained above, the first and second PCBs 200, 300 can be inserted into one another to form a crossed dipole. For example, FIG. 4A is a perspective view of the PCBs 200, 300 prior to insertion into one another, and FIG. 5A is a perspective view of the PCBs 200, 300 inserted into one another. As seen, the first PCB 200 can be aligned orthogonally with the second PCB 300, and the notch 220 of the first PCB 200 can be inserted into the notch 320 of the second PCB 300. The PCBs 200, 300 and their respective notches 220, 320 can be slid relative to one another until a top end of notch 220 engages with a bottom end of notch 320. Once the PCBs 200, 300 are inserted into one another, the conductors 210, 310 thereon can form a crossed dipole, and the combined structure can be inserted into an antenna base 500.

FIG. 4B is an enlarged view of a section of the antenna shown in FIG. 4A, and FIG. 5B is an enlarged view of a section of the antenna shown in FIG. 5A. As seen, a wire bridge 400 can physically and electrically connect with the first lower arm 314-2 at aperture 405-2 and with the second lower arm 315-2 at aperture 410-2. Similarly, the wire bridge 400 can traverse apertures 405-2, 410-2 and the PCB 300 at corresponding points to physically and electrically connect with the lower arms 314-1, 315-1 at apertures 405-1, 410-1, respectively. Furthermore, the wire bridge 400 can physically and electrically connect with the second lower arms 215-1, 215-2 by passing through apertures 415-1, 415-2, respectively.

When the first and second PCBs 200, 300 are inserted into each other, the wire bridge 400 can be soldered to and traverse apertures 405-1, 410-1, 405-2, 410-2 and apertures 415-1, 415-2. Additionally, solder can be applied at points where lower arms 214-1, 214-2, 314-1, 315-1 abut one another. Accordingly, when the first and second PCBs are inserted into each other, each of the lower arms 214-1, 215-1, 214-2, 215-2, 314-1, 315-1, 314-2, 315-2 can be connected to one another and to ground via the ground connection 330. Indeed, FIG. 6 is a top view of the PCBs 200, 300 inserted into one another and illustrates the wire bridge 400 connecting with the PCB 300 and traversing the PCB 200.

Furthermore, when the first and second PCBs 200, 300 are inserted into each other, solder can be applied through via holes 420-1, 425-1, 420-2, 425-2 and at points where upper arms 212-1, 213-1, 212-2, 213-2, 312-1, 313-1, 312-2, 313-2 abut one another. Accordingly, when the first and second PCBs 200, 300 are inserted into each other, each of upper arms 212-1, 213-1, 212-2, 213-2, 312-1, 313-1, 312-2, 313-2 can be connected to one another and to the feed microstrip line 335.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. An antenna comprising:
a first printed circuit board; and
a second printed circuit board,
wherein the first printed circuit board includes a first conductor of a crossed dipole,
wherein the second printed circuit board includes a second conductor of the crossed dipole,
wherein a first plurality of arms of the first conductor and a first plurality of arms of the second conductor are physically and electrically connected to a feed microstrip line disposed on a first side of the second printed circuit board,
wherein a second plurality of arms of the first conductor and a second plurality of arms of the second conductor are physically and electrically connected to a ground connection disposed on a second side of the second printed circuit board, and
wherein the feed microstrip line avoids physical and electrical connection with the second plurality of arms of the first conductor and with the second plurality of arms of the second conductor.

2. The antenna of claim 1, wherein the antenna operates in a frequency range of from approximately 690 MHz to approximately 2700 MHz.

3. The antenna of claim 1 wherein a first set of the first plurality of arms of the first conductor is disposed on a first side of the first printed circuit board, wherein a second set of the first plurality of arms of the first conductor is disposed on a second side of the first printed circuit board, wherein a first set of the second plurality of arms of the first conductor is disposed on the first side of the first printed circuit board, and wherein a second set of the second plurality of arms of the first conductor is disposed on the second side of the first printed circuit board.

4. The antenna of claim 1 wherein a first set of the first plurality of arms of the second conductor is disposed on the first side of the second printed circuit board, wherein a second set of the first plurality of arms of the second conductor is disposed on the second side of the second printed circuit board, wherein a first set of the second plurality of arms of the second conductor is disposed on the first side of the second printed circuit board, and wherein a second set of the second plurality of arms of the second conductor is disposed on the second printed circuit board.

5. The antenna of claim 1 wherein solder connects at least some of the first plurality of arms of the first conductor and the first plurality of arms of the second conductor.

6. The antenna of claim 5 further comprising a plurality of via holes disposed in the first plurality of arms of the second conductor, wherein at least some of the plurality of via holes receive the solder.

7. The antenna of claim 1 further comprising a wire bridge, wherein the wire bridge connects at least some of the second plurality of arms of the first conductor and the second plurality of arms of the second conductor.

8. The antenna of claim 7, wherein the wire bridge is soldered to the at least some of the second plurality of arms of the first conductor and the second plurality of arms of the second conductor.

9. The antenna of claim 7, wherein the wire bridge traverses the at least some of the second plurality of arms of the first conductor and the first printed circuit board at a first location.

10. The antenna of claim 7, wherein the wire bridge traverses the at least some of the second plurality of arms of the second conductor and the second printed circuit board at first and second locations.

11. The antenna of claim 1 wherein the feed microstrip line crosses the second plurality of arms of the first conductor and the second plurality of arms of the second conductor without physically or electrically connecting with the second plurality of arms of the first conductor and with the second plurality of arms of the second conductor.

12. The antenna of claim 1 wherein the first printed circuit board includes a first notch, wherein the second printed circuit board includes a second notch, and wherein the first printed circuit board engages the second printed circuit board by disposing the first notch into the second notch.

13. The antenna of claim 12 wherein the first printed circuit board is orthogonal to the second printed circuit board.

14. The antenna of claim 12 wherein at least some of the second plurality of arms of the first conductor are physically separated from the first notch.

15. The antenna of claim 14 wherein the physical separation between the at least some of the second plurality of arms of the first conductor and the first notch prevents the at least some of the second plurality of arms of the first conductor from physically and electrically connecting with the feed microstrip line.

16. An antenna comprising:
a first printed circuit board;
a second printed circuit board;
first and second upper arms of a first conductor of a crossed dipole disposed on a first side of the first printed circuit board;
first and second lower arms of the first conductor of the crossed dipole disposed on the first side of the first printed circuit board;
third and fourth upper arms of the first conductor of the crossed dipole disposed on a second side of the first printed circuit board;
third and fourth lower arms of the first conductor of the crossed dipole disposed on the second side of the first printed circuit board;
first and second upper arms of a second conductor of the crossed dipole disposed on a first side of the second printed circuit board;
first and second lower arms of the second conductor of the crossed dipole disposed on the first side of the second printed circuit board;
third and fourth upper arms of the second conductor of the crossed dipole disposed on a second side of the second printed circuit board;
third and fourth lower arms of the second conductor of the crossed dipole disposed on the second side of the second printed circuit board;
a ground connection disposed on the first side of the second printed circuit board; and
a feed microstrip line disposed on the second side of the second printed circuit board,
wherein each of the lower arms is physically and electrically connected to the ground connection,
wherein each of the upper arms is physically and electrically connected to the feed microstrip line, and
wherein the feed microstrip line crosses the lower arms to feed the upper arms while avoiding physical and electrical connection with the lower arms.

17. The antenna of claim 16 further comprising a bridge for connecting at least some of the lower arms.

18. The antenna of claim 16, wherein the antenna operates in a frequency range of from approximately 690 MHz to approximately 2700 MHz.
